(19) United States
(12) Patent Application Publication
(10) Pub. No.: US 2026/0279609 A1
(43) Pub. Date: Sep. 17, 2026

(54) REFUELLING AND/OR STORAGE NEUTRON-ABSORBING RODS

(71) Applicant: Rolls-Royce SMR Limited, Derby (GB)

(72) Inventor: Andrew KNIGHT, Derby (GB)

(21) Appl. No.: 19/680,022

(22) Filed: May 18, 2026

Related U.S. Application Data
(62) Division of application No. 18/016,777, filed on Jul. 14, 2021.

(30) Foreign Application Priority Data
Jul. 24, 2020 (GB) 2011493.0

(51) Int. Cl. G21C 19/40; G21C 7/24; G21C 19/20

(52) U.S. Cl. CPC G21C 19/40; G21C 7/24; G21C 19/205

(57) ABSTRACT

A nuclear reactor is provided. The reactor including: plural fuel rods containing fissile material; plural control rods, each made of a first neutron-absorbing material, the control rods being inserted between the fuel rods to reduce the rate of a fission reaction of the fission material and put the reactor in a shutdown state, but being operable to move in and out of the reactor to vary the rate of the fission reaction when the reactor is critical and generating useful power; and plural refueling and/or storage rods, each made of a second neutron-absorbing material different to the first material, the refueling and/or storage rods being inserted between the fuel rods to further reduce the rate of the fission reaction and maintain the shutdowns state.

### CROSS-REFERENCE TO RELATED APPLICATIONS

This application is a divisional of U.S. patent application Ser. No. 18/016,777 filed Jan. 18, 2023, which is a 35 U.S.C. § 371 national phase application of PCT/EP 2021/069559(WO-2022/017879-Al), filed on Jul. 14, 2021, entitled “REFUELLING AND/OR STORAGE NEUTRON-ABSORBING RODS”, and claims priority to GB-2011493.0 filed on Jul. 24, 2020, which is incorporated herein by reference in their entirety.

### FIELD OF THE INVENTION

The present disclosure relates to refuelling and/or storage rods of a nuclear reactor.

### BACKGROUND

Nuclear power plants convert heat energy from the nuclear fission of fissile material contained in fuel assemblies into electrical energy. Pressurised water reactor (PWR) nuclear power plants have a primary coolant circuit which typically connects the following pressurised components: a reactor pressure vessel (RPV) containing the fuel assemblies; one or more steam generators; and a pressurizer. Coolant pumps in the primary circuit circulate pressurised water through pipework between these components. The RPV houses the nuclear core which heats the water in the primary circuit. The steam generator functions as a heat exchanger between the primary circuit and a secondary system where steam is generated to power turbines. The pressurizer maintains a pressure of around 155 bar in the primary circuit.

The nuclear core is comprised of a number of fuel assemblies, with the fuel assemblies containing fuel rods, formed of pellets of fissile material. The fuel assemblies also include space for control rods. For example, a conventional fuel assembly provides a housing for a 17×l7 grid of rods i.e. 289 total spaces. Of these 289 total spaces, 24 may be reserved for the control rods for the reactor, each of which may be formed of 24 control rodlets connected to a main arm, and one may be reserved for an instrumentation tube. The control rods are movable in and out of the core to provide control of the fission process undergone by the fuel, by absorbing neutrons released during nuclear fission. A typical reactor core would include some 100-300 fuel assemblies. Fully inserting the control rods typically leads to a subcritical state in which the reactor is shutdown.

During refuelling or storage operations, it is important that a shutdown high safety margin is maintained in case control rods are inadvertently removed, or any other accident occurs which has the potential to degrade the shutdown margin, e.g. add positive reactivity. Therefore, a conventional approach has been to introduce a soluble boric acid solution to the primary circuit to allow ‘poisoned’ coolant to circulate within the reactor. This coolant is poisoned in the sense that it contains a substance with a very high neutron capture cross-section, and so starves the fissile material of neutrons to trigger another fission event.

Undesirably, boric acid is highly toxic and corrosive. It would be preferable then to provide the necessary safety margin in a way which does not require the use of this dangerous and environmentally damaging agent.

### SUMMARY

In a first aspect, there is provided a fuel assembly for a nuclear reactor having plural, individually extractable and replaceable fuel assemblies holding fuel rods of the reactor, and having plural control rods, each made of a first neutron-absorbing material, which are insertable between the fuel rods to reduce the rate of a fission reaction of fissile material contained within the fuel rods to put the reactor in a shutdown state, and operable to move in and out of the reactor to vary the rate of the fission reaction when the reactor is critical and generating useful power;
wherein the fuel assembly includes:
plural of the fuel rods containing fissile material; and
at least one refuelling rod, made of a second neutron-absorbing material different to the first mate-rial, the refuelling and/or storage rod being inserted between the fuel rods to further reduce the rate of the fission reaction and maintain the shutdown state.

Optional features of the assembly of the first aspect will now be set out. These are applicable singly or in any combination.

The refuelling rods are not required to be operable to survive the intense radiation flux or the high temperatures present in an operating or critical nuclear reactor. The refuelling rods are also suitable for storage of the fuel assemblies, and may be referred to herein as refuelling and/or storage rods.

The plurality of refuelling rods may be made of a borated metal. For example, the borated metal may be borated steel.

The plurality of refuelling rods may be immobilized within the fuel assembly. The fuel assembly may comprise a locking mechanism for mechanically locking the refuelling rod within the fuel assembly.

In a second aspect, there is provided a nuclear reactor including:
plural fuel rods containing fissile material, the fuel rods held in plural, individually extractable and replaceable, fuel assemblies of the reactor, and wherein at least one of the fuel assemblies comprise the fuel assembly described above in the first aspect. A plurality of fuel assemblies may comprise the fuel assembly of the first aspect, or in some examples all the fuel assemblies may comprise the fuel assembly of the first aspect.

Advantageously, the fuel assembly described when used in a nuclear reactor can enable refuelling and/or storage operations without the introduction of poisoned (e.g. borated) coolant. Moreover, the second neutron-absorbing material can be cheaper and simpler than the first neutron-absorbing material as it is not required to withstand the harsh environment inside a critical reactor, including high temperatures and high radiation fluxes.

In a third aspect, there is provided a procedure for reducing a rate of fission during the shutdown of a nuclear reactor including plural fuel rods containing fissile material, the procedure comprising the steps of:
inserting plural control rods, each made of a first neutron-absorbing material, between the fuel rods to reduce the rate of a fission reaction of the fissile material and put the reactor into a shutdown state; and
inserting plural refuelling rods, each made of a second neutron-absorbing material different to the first material, between the fuel rods to further reduce the rate of the fission reaction and maintain the shutdown state.

Thus, the fuel assembly of the first aspect can be used in the procedure of the third aspect.

In a fourth aspect, there is provided a method of refuelling a nuclear reactor, the method comprising:
performing the procedure of the third aspect to shut down the reactor;
removing a reactor vessel head of the reactor, thereby exposing the fuel rods within the reactor;
mechanically locking or immobilising the refueling rods in place;
refuelling the reactor; and
disimmobilising or unlocking and removing the refuelling rods.

Advantageously, the refuelling may be performed without introducing a neutron-poisoning solution, e.g. boric acid, to coolant water of the reactor.

The fuel rods may be held in plural fuel assemblies, at least one or more of the fuel assemblies each containing one or more of the refuelling rods. In the mechanically locking step the one or more refuelling rods may be mechanically locked in place within their respective assemblies. The method may then further comprise steps, between the steps of mechanically locking, and disimmobilising and removing, of: extracting a fuel assembly containing one or more of the refuelling rods from the reactor, and transferring it to a storage pool; and returning the extracted fuel assembly from the storage pool to the reactor. The step of refuelling may include refuelling the extracted fuel assembly while in the storage pond.

The fuel rods may be held in plural fuel assemblies of the reactor, at least one of the fuel assemblies containing one or more of the refuelling rods. In the mechanically locking step the one or more refuelling rods may be mechanically locked in place within their respective assemblies. The method may then further comprise a step, between the steps of mechanically locking, and unlocking and removing, of: extracting a fuel assembly containing one or more of the refuelling rods from the reactor, and transferring it to a storage pool. In addition, the step of refuelling may include transferring a replacement fuel assembly from the storage pool to the reactor, the replacement fuel assembly replacing the extracted fuel assembly. The replacement fuel assembly may include one or more of the refuelling rods.

The present invention may comprise or be comprised as part of a nuclear reactor power plant (referred to herein as a nuclear reactor). In particular, the present invention may relate to a Pressurized water reactor. The nuclear reactor power plant may have a power output between 250 and 600 MW or between 300 and 550 MW.

The nuclear reactor power plant may be a modular reactor. A modular reactor may be considered as a reactor comprised of a number of modules that are manufactured off site (e.g. in a factory) and then the modules are assembled into a nuclear reactor power plant on site by connecting the modules together. Any of the primary, secondary and/or tertiary circuits may be formed in a modular construction.

The nuclear reactor of the present disclosure may comprise a primary circuit comprising a reactor pressure vessel; one or more steam generators and one or more pressurizer. The primary circuit circulates a medium (e.g. water) through the reactor pressure vessel to extract heat generated by nuclear fission in the core, the heat is then to delivered to the steam generators and transferred to the secondary circuit. The primary circuit may comprise between one and six steam generators; or between two and four steam generators; or may comprise three steam generators; or a range of any of the aforesaid numerical values. The primary circuit may comprise one; two; or more than two pressurizers. The primary circuit may comprise a circuit extending from the reactor pressure vessel to each of the steam generators, the circuits may carry hot medium to the steam generator from the reactor pressure vessel, and carry cooled medium from the steam generators back to the reactor pressure vessel. The medium may be circulated by one or more pumps. In some embodiments, the primary circuit may comprise one or two pumps per steam generator in the primary circuit.

In some embodiments, the medium circulated in the primary circuit may comprise water. In some embodiments, the medium may comprise a neutron absorbing substance added to the medium (e.g., boron, gadolinium). In some embodiments the pressure in the primary circuit may be at least 50, 80 100 or 150 bar during full power operations, and pressure may reach 80, 100, 150 or 180 bar during full power operations. In some embodiments, where water is the medium of the primary circuit, the heated water temperature of water leaving the reactor pressure vessel may be between 540 and 670 K, or between 560 and 650 K, or between 580 and 630 K during full power operations. In some embodiments, where water is the medium of the primary circuit, the cooled water temperature of water returning to the reactor pressure vessel may be between 510 and 600 k, or between 530 and 580 K during full power operations.

The nuclear reactor of the present disclosure may comprise a secondary circuit comprising circulating loops of water which extract heat from the primary circuit in the steam generators to convert water to steam to drive turbines. In embodiments, the secondary loop may comprise one or two high pressure turbines and one or two low pressure turbines.

The secondary circuit may comprise a heat exchanger to condense steam to water as it is returned to the steam generator. The heat exchanger may be connected to a tertiary loop which may comprise a large body of water to act as a heat sink.

The reactor vessel may comprise a steel pressure vessel, the pressure vessel may be from 5 to 15 m high, or from 9.5 to 11.5 m high and the diameter may be between 2 and 7 m, or between 3 and 6 m, or between 4 to 5 m. The pressure vessel may comprise a reactor body and a reactor head positioned vertically above the reactor body. The reactor head may be connected to the reactor body by a series of studs that pass through a flange on the reactor head and a corresponding flange on the reactor body.

The reactor head may comprise an integrated head assembly in which a number of elements of the reactor structure may be consolidated into a single element. Included among the consolidated elements are a pressure vessel head, a cooling shroud, control rod drive mechanisms, a missile shield, a lifting rig, a hoist assembly, and a cable tray assembly.

Movement of the control rod may be moved by a control rod drive mechanism. The control rod drive mechanism may command and power actuators to lower and raise the control rods in and out of the fuel assembly, and to hold the position of the control rods relative to the core. The control rod drive mechanism rods may be able to rapidly insert the control rods to quickly shut down (i.e. scram) the reactor.

The primary circuit may be housed within a containment structure to retain steam from the primary circuit in the event of an accident. The containment may be between 15 and 60 m in diameter, or between 30 and 50 m in diameter. The containment structure may be formed from steel or concrete, or concrete lined with steel. The containment may house one or more lifting devices (e.g. a polar crane). The lifting device may be housed in the top of the containment above the reactor pressure vessel. The containment may contain within or support exterior to, a water tank for emergency cooling of the reactor. The containment may contain equipment and facilities to allow for refuelling of the reactor, for the storage of fuel assemblies and transportation of fuel assemblies between the inside and outside of the containment.

The power plant may contain one or more civil structures to protect reactor elements from external hazards (e.g. missile strike) and natural hazards (e.g. tsunami). The civil structures may be made from steel, or concrete, or a combination of both.

### BRIEF DESCRIPTION OF THE DRAWINGS

Embodiments of the invention will now be described by way of example with reference to the accompanying drawings in which:

FIG. 1 is a schematic diagram of a PWR;

FIG. 2 shows schematically a fuel assembly for the reactor of FIG. 1; and

FIG. 3 is a flow diagram of a method of refuelling the reactor of FIG. 1.

### DETAILED DESCRIPTION

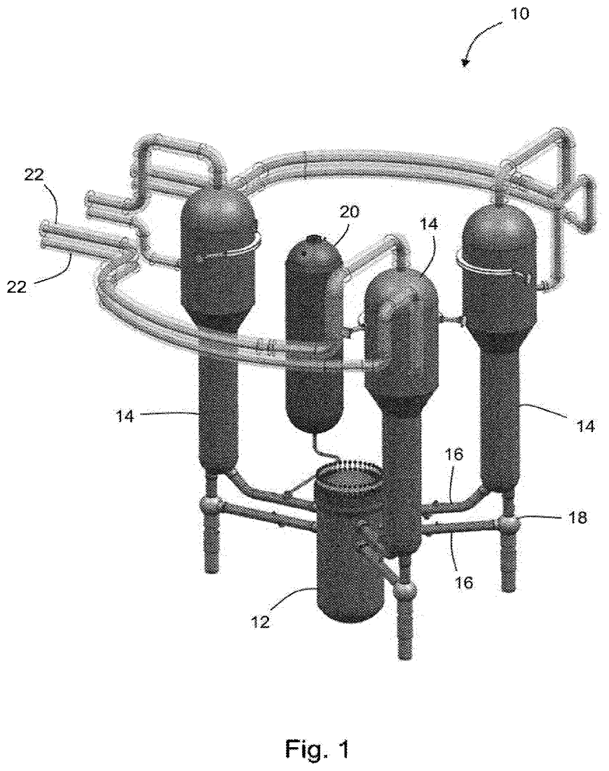

FIG. 1 is a schematic diagram of a PWR 10. An RPV 12 containing fuel assemblies centrally located in the reactor. Clustered around the RPV are three steam genera-tors 14 connected to the RPV by pipework 16 of the pressurised water, primary coolant circuit.

Coolant pumps 18 circulate pressurised water around the primary coolant circuit, taking heated water from the RPV to the steam generators, and cooled water from the steam generators to the RPV.

A pressurizer 20 maintains the water pressure in the primary coolant circuit at about 155 bar.

In the steam generators 14, heat is transferred from the pressurised water to feed water circulating in pipework 22 of a secondary coolant circuit, thereby producing steam which is used to drive turbines which in turn drive an electricity-generator. The steam is then condensed before returning to the steam generators.

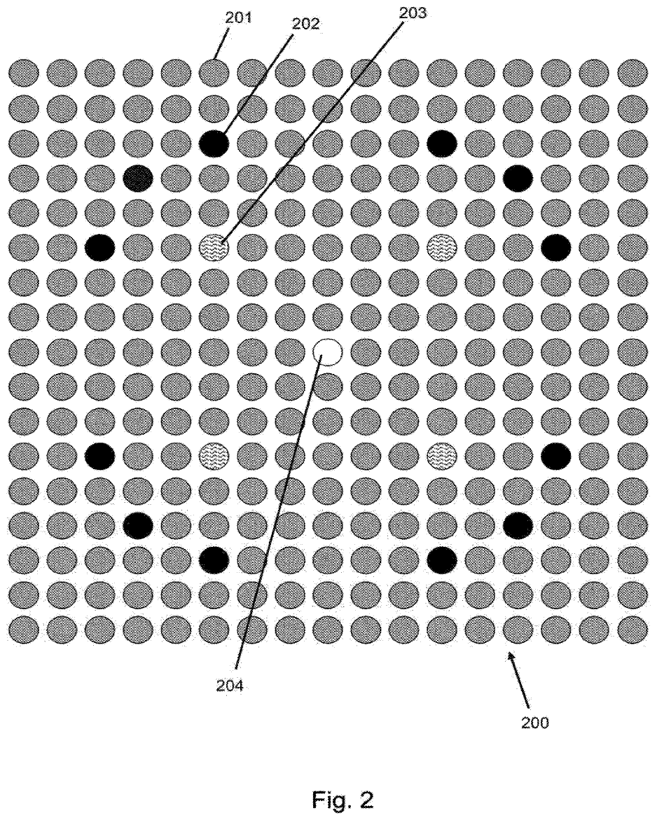

FIG. 2 shows an example layout of a fuel assembly 200, which is formed of a 17×l7 grid of rod guides. The grid is held together by metal banding (not shown). The grid of rod guides contain: fuel rods 201, control rods 202, refuel-ling and/or storage rods 203, and an instrumentation rod 204. Any control rod may be replaced, during a refuelling or storage operation, by a refuelling and/or storage rod 203. Further, not all rod guides within a fuel assembly need be filled. For example, the rod guide for one or more control rods 202 and/or refuelling and/or storage rods 204 may contain no rod. The instrumentation rod 204 typically contains one or more sensors, e.g. a temperature sensor, a radiation flux sensor, etc. In preferred examples, any given fuel assembly 200 would contain either control rods 202 or refuelling and/or storage rods 203 and not both. For example, all of the positions shown in FIG. 2 indicated as control rod positions could be used to house refuelling and/or storage rods 203. The opposite is also true.

The control rods 202 are operable to move in a direction which is in and out of the plane of FIG. 2, so as to present varying depths to the surrounding fuel rods 201 and thereby control the rate of the fission reaction in a manner known in the art. In particular, when the reactor is critical and generating useful power, the control rods can be moved to vary the rate of the fission reaction in real time, can also be fully inserted to put the reactor in a subcritical shutdown state. In contrast, the refuelling and/or storage rods 203, when present, are immobilised and do not move in and out of the fuel assembly in the same manner as the control rods, as discussed in more detail below. A role of the refuelling and/or storage rods is to ensure that substantially no fission reaction occurs during a refuelling operation or storage operation occurs i.e. the reactor is safely maintained in the subcritical shutdown state, as discussed in more detail below.

The fuel assembly may comprise a locking mechanism for mechanically locking the refuelling and/or storage rod within the fuel assembly. The locking mechanism may comprise for example, a cap or locking nut operable to be secured over each such rod to immobilise the refuelling and/or storage rod in the fuel assembly during refuelling operations and storage. Alternatively the locking mechanism could be separate to the fuel assembly and operable to be inserted into the fuel assembly to immobilise the refuelling and/or storage rod in the fuel assembly during refuelling operations and storage.

Typically, the control rods 202 are formed of a neutron-absorbing first material which meet the following criteria: (i) capture neutrons, and thereby moderate the rate of a fission reaction; (ii) survive the intense radiation flux present in an operating or critical nuclear reactor; and (iii) survive the high temperatures present within such a reactor. For example, control rods 202 can be made from AglnCd, Hf, B4C, or combinations thereof.

In contrast, the refuelling and/or storage rods 203 can be formed of a different, neutron-absorbing second material which only needs to satisfy the criteria (i) above. For example, the refuelling and/or storage rods may be formed from a borated material, such as borated steel or a borinated polymer. In one example, the refuelling and/or storage rods are formed from Borated Stainless Steel (BSS) as is known for use in fabricating fuel storage racks. The BSS would typically contain 0.6% by weight natural boron, with the remainder of the chemical composition being in common with normal stainless steel i.e. a mixture of iron, chromium, and nickel. In embodiments, the borinated mate-rial may comprise between 0.3% and 12% wt of boron; or between 0.4% and 6%; or between 0.5% and 2%; or between a range formed from any of the aforesaid endpoints.

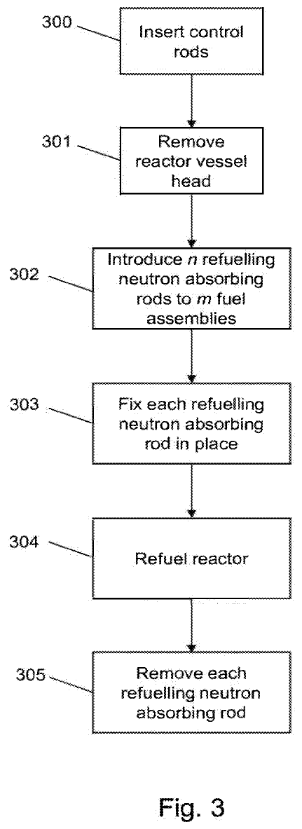

A method of refuelling a reactor having fuel assemblies such as that shown in FIG. 2 is illustrated in FIG. 3. In a first step, the control rods 202 are inserted to put the reactor in a subcritical shutdown state. In a next step, 301, the reactor pressure head is removed so as to expose the fuel assemblies contained within the reactor. Next, in step 302, n refuelling and/or storage rods 203 are introduced to m fuel assembles. The value of n will be determined by the level of suppression desired to safely prevent the reactor going critical, and would depend (amongst other factors) on the neutron capture cross-section of the material forming the refuelling and/or storage rods 203. The value of m will depend both on the value of n and also on the number of free rod guides within the reactor as a whole. Whilst step 302 is performed before step 301 in this example, it is possible to reverse the order i.e. first introduce n refuelling and/or storage rods to the m fuel assemblies and subsequently remove the reactor pressure head. The refuelling and/or storage rods further reduce the rate of fission occurring.

After the refuelling and/or storage rods 203 are introduced, they are immobilised in place in step 303. This can be performed, for example, by securing a cap or locking nut over each such rod. This ensures that, unlike the control rods 202 discussed previously, they cannot be inadvertently retracted from the fuel assembly in which they are located. This provides an additional safety margin not provided by a control-rod-only core. The control rods, in comparison, may be mounted to a moveable arm so as to allow them to be moved in and out of the core with relative ease.

After the refuelling and/or storage rods 203 are introduced, the reactor can be refueled in step 304. Option-ally, a step may also be performed of moving fuel assemblies within the reactor so as to balance any subsequent fission reaction.

After the step of refuelling and, when performed, the step of moving the fuel assemblies, each refuelling and/or storage rod 203 is disimmobilised (e.g. by removing the cap or locking nut) and removed in step 305.

The refuelling of the reactor can either be per-formed by replacing any given fuel rod within a fuel assembly, or, preferably, by replacing entire fuel assemblies. If the fuel assemblies are to be refueled, this may be performed in-situ within the reactor. Alternatively the fuel assembly(s) may be extracted from the reactor to a storage pool where fuel rods are replaced. Indeed, another option (and the preferred option) for accomplishing refuelling of the reactor is to swap over extracted fuel assemblies with replacement fuel assemblies held in the storage pool, i.e. the replacement fuel assemblies from the pool are transferred to the reactor to take the place of the extracted fuel assemblies, which can then be stored pending subsequent processing.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A method for reducing a rate of fission during shut down of a nuclear reactor including plural fuel rods containing fissile material, the method comprising the steps of:
inserting plural control rods, each made of a first neutron-absorbing material, between the fuel rods to reduce the rate of a fission reaction of the fissile material and put the reactor into a shutdown state; and
inserting plural refuelling rods, each made of a second neutron-absorbing material different to the first material, between the fuel rods to further reduce the rate of the fission reaction and maintain the shutdown state.

2. The method of claim 1 further comprising:
removing a reactor vessel head of the reactor, thereby exposing the fuel rods within the reactor;
mechanically locking the refuelling rods in place;
refuelling the reactor; and
unlocking and removing the refuelling rods.

3. The method of claim 2, wherein the refuelling is performed without introducing a neutron-poisoning solution to coolant water of the reactor.

4. The method of claim 2, wherein the fuel rods are held in plural fuel assemblies of the reactor, at least one of the fuel assemblies each containing one or more of the refuelling rods, and wherein, in the mechanically locking step, the one or more refuelling rods are mechanically locked in place within their respective assemblies, the method further comprising steps, between the steps of mechanically locking, and unlocking and removing, of:
extracting a fuel assembly containing one or more of the refuelling rods from the reactor, and transferring it to a storage pool; and
returning the extracted fuel assembly from the storage pool to the reactor.

5. The method of claim 4, wherein the step of refuelling includes refuelling the extracted fuel assembly while in the storage pool.

6. The method of claim 2, wherein the fuel rods are held in plural fuel assemblies of the reactor, at least one of the fuel assemblies each containing one or more of the refuelling rods, and wherein, in the mechanically locking step, the one or more refuelling rods are mechanically locked in place within their respective assemblies, the method further comprising a step, between the steps of mechanically locking, and unlocking and removing, of:
extracting a fuel assembly containing one or more of the refuelling rods from the reactor, and transferring it to a storage pool;
wherein the step of refuelling includes transferring a replacement fuel assembly from the storage pool to the reactor, the replacement fuel assembly replacing the extracted fuel assembly.
